(19) United States
(12) Patent Application Publication
(10) Pub. No.: US 2011/0265910 A1
(43) Pub. Date: Nov. 3, 2011

(54) ECCENTRIC FUNNEL FOR FEEDING LIQUID ALUMINUM

(76) Inventor: André Mueller, Le Landeron (CH)

(21) Appl. No.: 13/143,261

(22) PCT Filed: Jan. 4, 2010
(86) PCT No.: PCT/CH2010/000001

§ 371 Date: Jul. 20, 2011

(30) Foreign Application Priority Data
Jan. 6, 2009 (CH) 12/09

(51) Int. Cl. B67C 11/00

(52) U.S. Cl. 141/331

(57) ABSTRACT

An eccentric funnel (1) for feeding liquid aluminum to the fill chamber of a die casting machine is arranged above the same and includes an upper part (2) designed as a feed channel (4) and connected to a lower part designed as a filling tube (3). Following a straight starting piece (5), the feed channel (4) continues with ever increasing curvature, until it ends over the opening of the filling tube (3) in congruence therewith. In this way, the aluminum is given a rotary motion, whereby a homogeneous flow is achieved. Over the filling tube (3), the speed of the aluminum is drastically reduced, so that it is conducted at a low impact speed downward into the filling chamber, taking up the opening surface of the filling tube (3). In this way, washout and erosion is prevented in the filling chamber, thereby achieving a long service life of the die casting machine.

### BACKGROUND

The present invention relates to an eccentric funnel for feeding liquid aluminum into the fill chamber of a die casting machine.

The feeding of liquid aluminum into the fill chamber of a die casting machine by means of a ladle or a channel is connected with the disadvantage that a fill funnel always leads the aluminum basically in a point-like manner to the same position of the fill chamber. In addition, due to the high impact rate, washouts and erosions in the fill chamber are generated very quickly, which quickly leads to early replacement of the fill chamber and to machine stoppage times. The invention now sets itself the task of avoiding the mentioned disadvantages and of creating a filling device with which the aluminum is led into the fill chamber distributed across a large surface area with a small drop height and thus the machine stoppage times are shortened.

### SUMMARY

The stated objective is now met by the eccentric funnel for feeding liquid aluminum into the fill chamber of a die casting machine according to the invention, such that the eccentric funnel has an upper part that is larger than the feed channel and transitions into a lower part that is smaller than the vertical fill tube, wherein, following a starting piece with inner wall and outer wall with an approximately U-shaped cross section, the feed channel continues in a spiral shape with ever increasing curvature with the outer wall with the base part forming the arc of the U until the edge of the base part reaches the circular opening of the fill tube and is further aligned with it until the outer wall is connected again to the inner wall of the starting piece. Advantageous constructions of the subject matter of the invention are listed in the additional claims.

### BRIEF DESCRIPTION OF THE DRAWINGS

Below, an embodiment of the eccentric funnel according to the invention will be explained in more detail with reference to the drawing. Shown therein are:

FIG. 1 an illustrative view of the eccentric funnel at an angle from above, and

FIG. 2 a section view of the eccentric funnel of FIG. 1 from above.

### DETAILED DESCRIPTION OF THE PREFERRED EMBODIMENTS

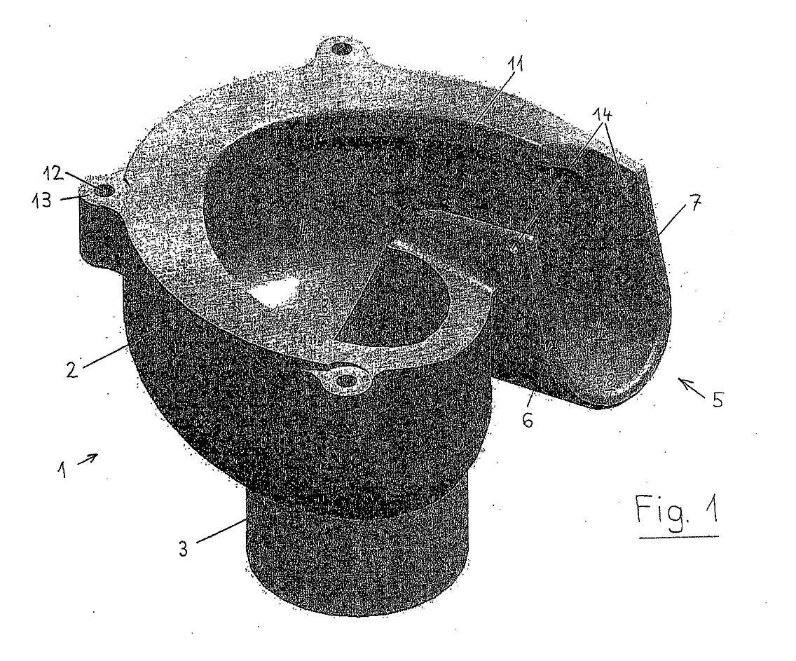

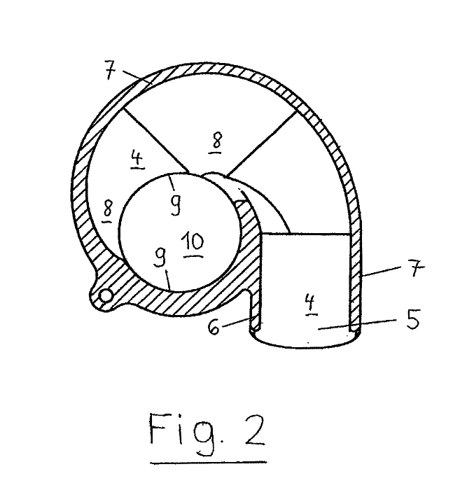

According to FIG. 1, the eccentric funnel 1 includes a larger upper part 2 and a smaller lower part designed as a fill tube 3. The upper part 2 is constructed as a feed channel 4 that has, as the starting piece 5, an inner wall 6 and an outer wall 7 that are connected to each other, forming a U-shaped cross section. Following the starting piece 5, the outer wall 7 with the base part 8 which forms the arc of the U has a spiral shape with ever increasing curvature, so that the edge 9 (FIG. 2) of the base part 8 reaches the circular opening 10 of the fill tube 3 and is further aligned with it until finally the outer wall 7 is connected again to the inner wall 6 of the starting piece 5. The inner wall 6 and outer wall 7 end here in that they drop to the base part 8.

The upper part 2 has a projection 11 and also three relief sections 13 provided with holes 12. Two holes 14 are also present in the starting piece 5.

In casting operation, the eccentric funnel 1 is affixed onto a bent sheet by means of three bolts guided by the holes 12. The bent sheet is simply placed on the die casting machine so that the fill tube 3 comes to lie at a right angle above the fill chamber. Thus, the eccentric funnel could also be easily disassembled again. The holes 14 are used for attaching a feed channel or a ladle. When feeding the liquid aluminum, a rotational motion is now imparted to it in the eccentric funnel 1 through the construction of the feed channel 4, wherein a homogeneous flow and a reduction of the turbulence is created. Because the aluminum has a tendency, at the beginning, to climb up the outer wall, this is prevented by the projection 11. The fill time is not reduced by the rotational motion, but the speed of the aluminum is reduced across the circular opening 10 and the aluminum then falls along practically the entire opening surface area of the fill tube 3 at a right angle into the fill chamber of the die casting machine. In this way, the impact is carried out on a large surface area at a greatly reduced speed. Because, with the described method, the height of the fill tube can be kept small, another reduction of the impact speed is created. Because the eccentric funnel is arranged above the fill chamber, it is also kept warm by this chamber, so that no heating is required. So that a long service life is imparted not only to the fill chamber, but also to the eccentric funnel, the surface area of the fill channel is provided with a ceramic coating.

1. Eccentric funnel for feeding liquid aluminum into a fill chamber of a die casting machine, the eccentric funnel (1) has a larger upper part (2) designed as a feed channel (4) and transitions into a smaller lower part designed as a vertical fill tube (3), wherein, following a starting piece (5) with an inner wall (6) and an outer wall (7) with approximately U-shaped cross section, the feed channel (4) continues in a spiral shape with ever increasing curvature with the outer wall (7) with a base part (8) forming an arc of the U until an edge (9) of the base part (8) reaches a circular opening (10) of the fill tube (3) and is further aligned therewith until the outer wall (7) is connected again to the inner wall (6) of the starting piece (5).

2. Eccentric funnel according to claim 1, wherein the outer wall (7) is provided with a projection (11).

3. Eccentric funnel according to claim 2, wherein the outer wall (7) has, at a height of the projection (11), three relief sections (13) provided with holes (12).

4. Eccentric funnel according to claim 3, wherein two holes (14) are arranged in the starting piece (5).

5. Eccentric funnel according to claim 1, wherein a surface of the fill channel (4) is provided with a ceramic coating.
